(19) United States
(12) Patent Application Publication
(10) Pub. No.: US 2007/0252303 A1
(43) Pub. Date: Nov. 1, 2007

(54) Production Method for Sound Deadening Structure

(76) Inventors: Mark V. Loen, Maricopa, AZ (US); James E. Velllky, Jacksonville, FL (US); Lillian B. Loen, Maricopa, AZ (US)

Correspondence Address: LOEN PATENT SERVICES, 43649 W BAILEY DRIVE, MARICOPA, AZ, 85239, US

(21) Appl. No.: 11/736,102

(22) Filed: Apr. 17, 2007

Related U.S. Application Data
(60) Provisional application No. 60/745,087, filed on Apr. 18, 2006.

(51) Int. Cl. B29C 33/40

(52) U.S. Cl. 264/219

(57) ABSTRACT

This invention discloses a unique and economical method of creating a metal and polymer fused strip structure with significant sound deadening qualities. It is produced by a filler bonding process. The polymer may incorporate one of many polymers known to create a high level of adhesion between the polymer and the metal. A variety of metals and polymers may be used.

### CROSS-REFERENCE TO RELATED APPLICATIONS

This application claims the benefit of U.S. Provisional Application No. 60/745,087, filed Apr. 18, 2006.

### STATEMENT REGARDING FEDERALLY SPONSORED RESEARCH OR DEVELOPMENT

Not applicable

### REFERENCE TO A SEQUENCE LISTING, A TABLE, OR A COMPUTER PROGRAM LISTING

Not applicable

### BACKGROUND OF THE INVENTION

An energy and sound deadening steel is an attractive material for reducing the background noise inside an automobile. Steel panels with sound deadening properties may be used in key components around the car. Existing commercial metal-filler-metal products that provide sound deadening properties are produced by undisclosed production methods and materials. The price of the sound deadening material is very high, compared to standard steel panels, causing the use of this material to be restricted to very high value products.

It is difficult to create a highly rigid part that also has sound deadening properties. Parts that are made out of metals, in particular metal stampings from flat rolled metals, have inherent resonant frequencies that are activated by small vibrations or small impact forces. The resonant frequencies add to noise in a variety of applications.

Automotive companies compete on a wide variety of factors which include creating a satisfactory ride. Noise in the passenger compartment is one important element of a satisfactory ride. Because the cost of existing sound deadening structures is very high, a low cost scaleable production method is needed that will allow widespread adoption of sound deadening throughout the automobile industry. Additionally, cost effective materials used for sound deadening need to be utilized.

It is known that automotive parts stamped out of flat steel strip have distinct resonant vibrating frequencies. For example, if you strike an automotive floor pan with a soft hammer it will create a sound according to its resonant frequencies. It will ring for a period of time which normally dampens out after several seconds. When installed on an automobile, the resonant frequency of the floor pan is continually activated by road vibrations, engine vibrations, air movement, etc. which adds to the noise heard by the passengers. Resonant sounds from the floor pan can be dampened out by padding and carpet, but it is far more attractive to provide for dampening within the part and eliminate the noise at the source.

Automobile parts can be redesigned to change the frequency of resonance and attempt to make it harder to activate. For example, ribbing can be added to a floor pan that elevate a troublesome resonant frequency, and require a larger striking force to cause it to ring. However, the design change may cause other, higher resonant frequencies to be activated with normal road and engine vibrations. Resonant frequencies are not eliminated or rapidly dampened. It is preferable to avoid resonance altogether by providing for a significant sound dampening effect.

Appliance companies also compete on the control of sound in their products. The ability to hinder the sound from motors, agitators, rotating drums, fans, and water sprays is an important aspect of product acceptance in the marketplace. It is known that consumers pay a premium for quieter appliances such as dishwashers. Metal drums, outer panels, motor mounting parts, and inner walls also have distinct resonant frequencies that can be sound dampened by the present invention.

Architecture companies also compete on the control of sound in their products. Roofing panels made out of metals, such as aluminum and steel, are known to be louder in a rain than alternate materials such as asphalt shingles. Rainfall activates the natural resonant frequencies of the roofing panels causing them to make an objectionable amount of sound. It is highly preferable to adapt metal roofing panels so that their resonant frequencies are immediately dampened by a suitable material within the panel rather than provide for padding or other sound control methods. This problem has hindered the widespread adoption of metal roofing materials that are exposed to rainfall.

It is also preferable to have options to reduce noise from HVAC systems. In particular, existing metal ductwork systems vibrate from the flow of air, fans, motors, and machinery. They are not designed to reduce noise in office or residential buildings. Sound dampening metal ductwork is appealing to reduce noise within a building.

It is also preferable to have options to reduce noise in the airline transportation industry. In particular, existing interior and exterior panels made out of aluminum and titanium alloys vibrate from the flow of air and engines. Sound dampening metal is highly appealing to reduce noise within the interior of an airplane or jet.

It is also preferable to provide for sound dampening in the ceilings and walls of home theater or commercial theater rooms.

### BRIEF SUMMARY OF THE INVENTION

The present invention is a unique and economical method of creating a metal and polymer fused structure by use of a thin filler polymer bonding process. The polymer may be selected from one of many polymers known to create a high level of adhesion between the polymer and the metal. A variety of metals and polymers may be used which are suitable to a particular application.

The present invention is a simple filler bonding process, using commonly available and affordable energy-sound dampening filler materials, which provide extraordinary energy and sound deadening performance. The process and method of production are highly simplified and tailored to produce sound deadening material at an affordable and scaleable production volume. The production process inherently has a low production cost. The scaling of the production process can be varied from a high speed continuous production down to a smaller, batch operation. Both operations have similar operating cost structures.

### BRIEF DESCRIPTION OF THE SEVERAL VIEWS OF THE DRAWING

FIG. 1 is a general elevation arrangement of a production line using the filler bonding process in a batch operation.

FIG. 2 is a general elevation arrangement of a different embodiment of a production line using the filler bonding process in a batch operation.

FIG. 3A-3C are cross sections of the metal and filler polymer fused structure.

FIG. 4 is general elevation arrangement of a production line using the filler bonding process in a batch operation that creates a five layer composite sound dampening structure.

FIGS. 5A-5B are graphs illustrating typical sound deadening performance of a flat rectangular sample.

FIGS. 6A-6B are graphs illustrating typical sound deadening performance of a flat rectangular sample with a stronger applied striking force.

FIG. 7 is a production line similar to FIG. 2 where a cleaning section is included to prepare the metal strip for boding with the filler polymer.

FIG. 8 is a three layer sound deadening fused metal strip composite structure with decorative coatings on the outside metal strip surfaces.

### DETAILED DESCRIPTION OF THE INVENTION

In the present invention, the sound dampening structure is a multi layer fusion of metal and polymer. This structure is created at a low cost that provides the necessary sound deadening properties, suitable part stiffness, and an optimized cost vs. sound deadening properties. The composite structure is at least three layers thick. The composite structure may be highly stiff and suitable for a variety of parts with significant strength requirements.

In the present invention, a filler polymer is used to provide the main energy-sound deadening effect in a fused metal and polymer structure. As an example, a typical automotive metal floor pan will have a thickness of 0.034″. For a sound deadened floor pan, two outside metal skins that are each 0.020″ thick are bonded together with an inside 0.001″ thick filler polymer. An overall fused metal structure of 0.041″ thick replaces a standard metal floor pan thickness of 0.034″ with similar structural stiffness in the formed part.

According to this invention, the thickness of metal varies and the thickness of the filler polymer varies with the application. The metal thickness and polymer thickness can be changed depending upon the resonant frequency in the part that is being avoided. Resonant frequencies are modeled at less than 20,000 hertz in the finished part and the significant frequencies are typically less than 8000 hertz.

A preferred type of filler polymer according to the teaching of this invention is a polyethylene, polypropylene, polyester, polystyrene, rubber, or foam. Each filler polymer is selected based on the variable properties of each polymer and the contribution made to the desired sound deadening properties. In particular, it is preferable for the polymers to be modified so that they provide adhesive functionality, such as being acid modified. A homogeneous filler layer is a preferred embodiment; a multi layer filler polymer structure may also be used. Polyethylene and polypropylene are preferably modified with maleic anhydride, such as are commonly used in commercial tie layers.

Readily available filler polymers that are suitable and provide significant adhesive properties along with sound deadening include:
1. Ethylene/Vinyl Acetate Copolymers (EVA).
2. Ethylene/Methyl Acrylate Copolymers (EMA) or Ethylene/Butyl Acrylate Copolymers (EBA).
3. Ethylene/Acrylic Ester/Maleic Anhydride (or Glycidyl Methacrylate) terpolymers.
4. Ethylene/Vinyl Acetate/Maleic Anhydride terpolymers.
5. Anhydride grafted polyolefins, including polypropylene and polyethylene.
6. Ethylene Acrylic Acid.
7. Polyolefins modified to include a carboxylic acid.

A filler polymer may also be a polyester such as PET, PBT. For adhesion, the polyester may include a glycol group such as PETG. Alternatively, polyesters may be admixed with various polymers, mineral fillers, and epoxies that provide needed adhesive and sound deadening functionality. Other functionality groups such as acrylic, methacrylate, epoxy, and carboxyl may also be included or by mixing a suitable polymer with such modifications into the filler polymer. These groups, and their adhesive qualities to metal surfaces, are known in the art. Since the filler polymer is not exposed to scratching or the need for a good cosmetic appearance, costs incurred to make the filler polymer visually attractive or scratch resistant may be avoided.

Other notable filler polymers may be comprised of a majority of polypropylene, polyethylene, polycarbonate, polyester, a copolymer of acrylonitrile-butadiene-styrene, polystyrene, polyvinylchloride, vinyl, acetal, nylon, polyurethane, polyamide, polyarylate, polyetherimide, polyetherketone, polyphenylene sulfide, rubber, fluoropolymer, or polysulfone. These resins may be used with other polymers in mono or multi layer filler polymer structures that provide for adhesion and sound deadening properties.

For example, a filler polymer may be a three layer structure of an anhydride modified PP, a bulk PP, and an anhydride modified PP in a ratio of 15%:70%:15% respectively. The anhydride modified PP provides for adhesion to the metal strips. This provides for a cost effective filler polymer which minimizes the need for the more expensive anhydride modified PP. The bulk PP may be a virgin resin, or a recycled resin.

It has been seen that a sufficient amount of adhesion between the filler polymer and the metal can be realized with at least 0.1% maleic anhydride by weight, if that is the only functional group used for bonding. A preferred amount of adhesion is measured with at least 0.25% maleic anhydride by weight.

In a preferred embodiment, the filler polymer may incorporate a recycled polymer. Use of a recycled polymer is a highly attractive way to lower overall production costs. For example, a filler polymer may be a monolayer of 90% recycled polypropylene blended with 10% prime anhydride modified polypropylene which has 2.5% maleic anhydride by weight. The resulting filler polymer will have 0.25% maleic anhydride which is sufficient for a high amount of adhesive force.

It is important to provide for a suitable and continuous adhesive force between the filler polymer and the metal so that a formed part will behave in a highly predictable manner. If there is loss of adhesion for some of the part, the sound deadening capability of the polymer is compromised and unpredictable.

Much of the sound deadening property is believed to come from the lower stiffness of the filler polymer, which generally has an elastic modulus between 150,000 to 900,000 psi. The filler polymer therefore inherently has the capability of absorbing deflection energy efficiently and distributing the energy of motion throughout a finished part.

It is important that there is sufficient adhesive force between the filler polymer and the metal. Generally, an adhesive force of at least 500 grams per linear inch as measured by the force required to peel the metal from the filler polymer is needed for parts with minimal stamping or bending forces. In a preferred embodiment, adhesive forces between the filler polymer and the two metal surfaces are at least 1,000 grams per linear inch. This adhesive force is suitable for a wide variety of stamped parts and still maintain complete bond between the metal and filler polymer.

In a commercial setting, production issues may allow a minor amount of air entrapment between the filler polymer and the metal surface. Air may be entrapped between the filler polymer and the metal when the surface energy of the metal is insufficient for complete wet out of the polymer. This normally is not a significant quality problem, provided that there is sufficient bonding between the filler polymer and metal. The sound dampening effect is not significantly impacted.

The sound dampening effect of the present invention is believed to be due to the method of coupling two metals together so that any resonant vibration must occur in the entire fused structure. The filler polymer softens the deflection between the two metals and acts as a cushion. The softer polymer tends to compress and disperse the deflection energy throughout the part rather than allow the deflection to transfer to both metal strips. Surprisingly, a highly effective sound dampening effect has been measured with filler polymer thickness as low as 0.0004″.

It is desirable to combine a number of different polymers that may be compatible or incompatible. The modifications may create hybrid polymer properties and are especially useful in creating sound deadening effects.

A foam may also be used as a filler polymer with a prescribed density through extrusion methods that are known in the art. The use of foams will require additional part thickness as the filler will typically need to be more than 5 mils thick to be effective. The final end use must be designed to allow needed additional thickness. Foam provides significantly different sound deadening properties, and is another preferred embodiment.

Another embodiment of the present invention is to use a controlled amount of air space within the filler polymer. If the filler polymer is a solid film, a pattern of holes can be created in the film to provide unique sound deadening properties. The holes may be in a fixed, regular pattern, or the may be in a random pattern and size.

A rubber may also be used as a filler polymer.

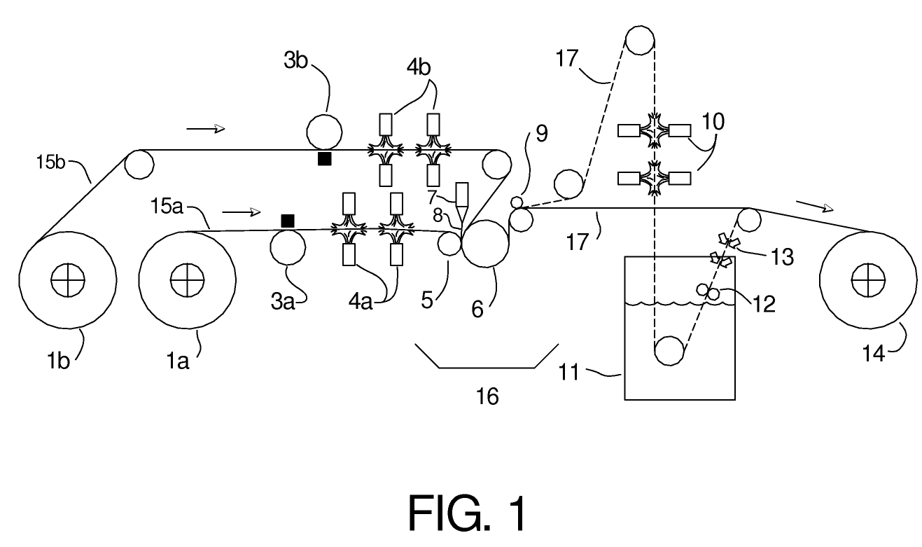

FIG. 1 shows a general arrangement of a batch production facility. Two similar unwind reels 1a, 1b continuously pay off steel strip 15a, 15b to a surface pretreatment section. An optional corona treatment 3a, 3b may be used to increase the surface energy of the metal. Next, a surface flame pretreatment is applied that consists of a plurality of surface conditioning burners 4a, 4b where the fuel to combustion air ratio is carefully controlled, as is well know in the art. The flame touches the metal surface as illustrated, or alternatively, it may be only near the steel surface. In FIG. 1, the flame is pretreating both metal sides. Alternately, only the side that will contact the filler polymer is surface treated. The primary purpose of the surface flame is to clean the steel surface, and provide an increase in surface energy as is well known in the art. The flame may also be increased in power and provide a preheating effect on the steel.

A clean and energy activated surface is normally necessary to obtain the required adhesion and wet out between the filler polymer and metal. Surface treatments that increase the surface energy may be applied that are known in the art; including controlled flame, corona, and plasma types. The need for surface treatment and heating depends upon the polymer used. Typically, the preheating is at a level which will allow the steel surface to be above the glass transition temperature or melting temperature of the filler polymer just prior to the contact point with the filler polymer. Heating may be provided by conduction, induction, radiant, convection, and electrical resistance methods.

An extrusion station 16 provides an extruded molten filler polymer film 8 from a die 7 that is feed by a least one extruder (not shown). The molten filler polymer film 8 and is fed between the two steel strips 15a, 15b. The extrusion station 16 includes a nip roll 5 and a temperature controlling roll 6. The nip roll 5 provides pressure against the temperature controlling roll 6 to prevent air entrapment between the two steel strips 15a, 15b and the molten filler polymer film 8. The temperature controlling roll 6 may cool the metal-polymer-metal structure 17, or it may heat it. In a preferred embodiment, the temperature controlling roll 6 cools the metal-polymer-metal structure 17 so that the filler polymer is below its melting point. A side trimming operation 9, is preferably a score cut trimmer where only the excess filler polymer 8 that overhangs the metal edges is trimmed. The metal-polymer-metal structure 17 continues to a winding reel 14. Normally, both metal strips 15a, 15b are substantially the same width, but this is not a requirement.

The production line may be configured to include a reheating and quench operation. In FIG. 1, the alternate routing of the metal-polymer-metal structure 17 is shown in a dashed line. In this case, the metal-polymer-metal structure 17 is routed through a reheating operation where burners 10 provide energy to remelt the filler polymer above its melting point. The strip is then quenched in a water tank 11 where the metal-polymer-metal structure 17 is rapidly cooled. The additional reheating step provides additional activation of adhesive functionality between the filler polymer and the metal strips. The metal-polymer-metal structure 17 then passes through a set of wringer rolls 12 and air blow offs 13.

An alternate simplified production method is to pretreat only the metal surfaces that will contact the filler polymer by controlled flames, extrude the filler polymer between the metal strips which are in turn between a pair of pressure rolls, and cool the composite structure. This production method will work with polymers that wet out exceptionally well on the metal surface. However, small amounts of air entrapment are likely to be embedded with some polymers that do not wet out well.

An alternate simplified production method is to pretreat only the metal surfaces that will contact the filler polymer by corona, extrude the filler polymer between the metal strips which are in turn between a pair of pressure rolls, cool the metal-polymer-metal structure, and wind it up.

An alternate simplified production method is to preheat the metal strips, extrude the filler polymer between the metal strips which are in turn between a pair of pressure rolls, cool the metal-polymer-metal structure, and wind it up.

The use of an extrusion process to create the filler polymer provides for a simple, low cost capital investment. This is especially true if an extrusion coating line is compared to installation cost of a paint line. If the extruder die is set up correctly, and the output of the extruders is well known, the fused structure can be created without the need for dynamic and complicated profile feedback and control. This will create a very simple process to monitor and control.

FIG. 1 shows a horizontal pretreating process prior to the contact point with the filler polymer. The pretreating may also be performed in a vertical pass. It is preferable that once the metal surface is prepared for contacting the filler polymer, it does not touch any deflector roll which may allow surface contaminants to be brought into contact with the metal surface.

FIG. 1 shows a vertical process for contacting the molten film with the two metal surfaces. This process may also be horizontal.

FIG. 1 is only one embodiment of how a production line may be set up. The processing steps that will satisfactorily create a suitable metal-polymer-metal composite structure are:
1. Pretreat the metal side by at least one of the following in any sequence:
   a. Priming the metal surface, and
   b. Any surface treatment which increases the surface energy of the metal surface or primed metal surface which will be contacted by the filler polymer.
2. Optionally preheating at least one of the metal strips.
3. Insert a filler polymer with adhesive qualities between both metal strips which are between a pair of rolls that apply pressure. The filler polymer may be solid film or in a molten state from an extruder.
4. Cool the resulting metal-polymer-metal composite structure as needed for winding or further processing.

Optional, additional processing steps are:
5. Reheat the metal-polymer-metal composite structure preferably above the melting point of the filler polymer.
6. Cool the resulting metal-polymer-metal composite structure to a selected temperature.

Methods of priming the metal surfaces for adhesion to the filler polymer include any of the following in any sequence:
1. Acid or alkaline cleaning followed by rinsing,
2. Surface passivation,
3. Conversion coating,
4. Chemical surface treatments known to improve adhesion to coatings,
5. Increasing surface roughness, and
6. Application of a thin liquid organic coating.

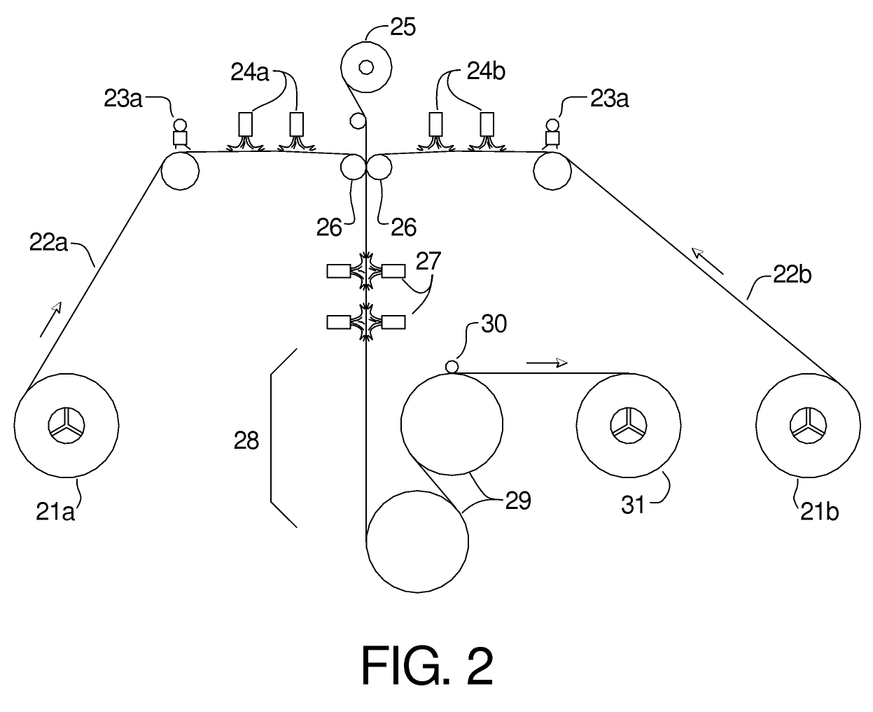

These methods may be employed in combination with the steps shown in FIGS. 1 and 2.

If either metal surface that will contact the filler polymer is heavily oiled, the surface is unsuitable for polymer adhesion to the metal surface. In this case, the metal surface can be cleaned in conventional wet cleaning section, as are often seen on coil processing lines, using a suitable cleaning solution, rinse section, and drying section.

It is preferable to include suitable equipment to coat the exposed metal surfaces with any customer requested surface oils or lubricants at the end of the production line. This kind of equipment is well known in the art.

The process shown in FIG. 1 is very efficient from the standpoint of utilizing all extruded filler polymer. Any excess polymer trimmed from the metal edges may be recycled back into the extruder and become a part of the extruded filler polymer again. This recycling feature creates a highly efficient use of the filler polymer, and provides for polymer yields approaching near 100 percent. General methods for the recycling of trimmed polymers are known in the art. For better economics it is important that the side trimming operation only removes polymer and does not trim any metal. A score cut trimming operation is preferred, but other polymer trimming equipment may be employed with equal success.

The present invention is generally suitable for a fused structure that is at least 0.004″ thick. It is preferable that at least one metal strip is at least 0.003″ thick for process line reliability. In a preferred embodiment, the metal strips to be coated are tinplate or light gauge metallic coated steel, such as galvanized or electroplated zinc steel. In another preferred embodiment, at least one of the metal strips to be coated is stainless steel or aluminum. In another preferred embodiment, one of the metal strips is aluminum foil. In another preferred embodiment, at least one of the metal strips is an alloy of titanium.

It is preferable that the edges of the two metal strips are substantially lined up at the point of contact with the filler polymer. For efficiency, an appropriate strip guiding system may be employed on the metal strips or polymer film just prior to the contact point. This makes efficient use of the metal strips, without the need to employ a metal side trimming operation.

FIG. 2 shows a slightly different embodiment of creating the metal-polymer-metal fused composite structure by using a solid filler polymer film. Two similar unwind reels 21a, 21b continuously pay off steel strip 22a, 22b to a surface pretreatment section consisting of an optional atmospheric plasma treatment 23a, 23b and a controlled surface flame treatment 24a, 24b. The amount of energy used in the surface flame pretreatment 24a, 24b is large enough to cause the temperature of the metal to rise significantly, to a temperature suitable for bonding to the filler polymer. A roll of solid filler polymer film 25 pays into the nip between a pair of pressure rolls 26 which ensure that the film and metal strips 22a, 22b are in complete contact across their width. Optional flame reheating burners 27 are immediately following and provide a boost in metal temperature, if needed, to ensure the film bonds completely. An optional short delay section 28 may be employed if the chemical bond between the filler polymer film and the metal surfaces requires an activation time. Two temperature control rolls 29 cool the metal-polymer-metal fused structure to a suitable temperature for winding on a winding reel 31. An optional side trimming operation 30 may be employed if the filler polymer film significantly extends past the metal edges. Preferably, the solid filler polymer film has been created by a process which includes an extruder.

In either method of production in FIGS. 1 and 2, the production amount can be suitably scaled to a large scale continuous production with an annual production rate of over 500,000 tons per year with line speeds well over 500 fpm. It can also be scaled back to a small, batch operation with a production capacity of 10,000 tons per year at speeds less than 20 fpm. The operational economics are similar in both cases. A continuous operation may effectively be retrofitted to a previous line where suitable strip splicing and looping towers are already available. Production economy is similar between a batch production operation and a continuous production operation where the coils are spliced together. According to the practices of this invention, the metal and polymer filler material costs dominate the final production cost.

The extensive use of flame heating and pretreating, in particular, creates a simple and highly cost efficient method of preparing the metal for filler polymer bonding to the metal. Flame heating provides the lowest capital and operational cost. Consideration for even heating control is improved by using specialized ribbon burners, dynamic burner position adjustment, and temperature feedback. However, an induction, infrared, or resistance heating may also be employed with success.

In a preferred embodiment, a lower cost filler polymer is used. Since the quality of the filler polymer is not highly critical, minor amounts of gels can be tolerated in the extrusion process. Other highly critical quality parameters often seen in polymer coating systems are not of importance in this operation.

It is preferable that the adhesive force between the two metal strips is at least 500 grams per inch. This adhesion force will ensure that the fused structure will stamp out correctly into a finished part without significant delamination or adhesive failure. Preferably, the adhesive force is 1,000 grams per inch and most preferably the adhesive force exceeds 1,500 grams per inch.

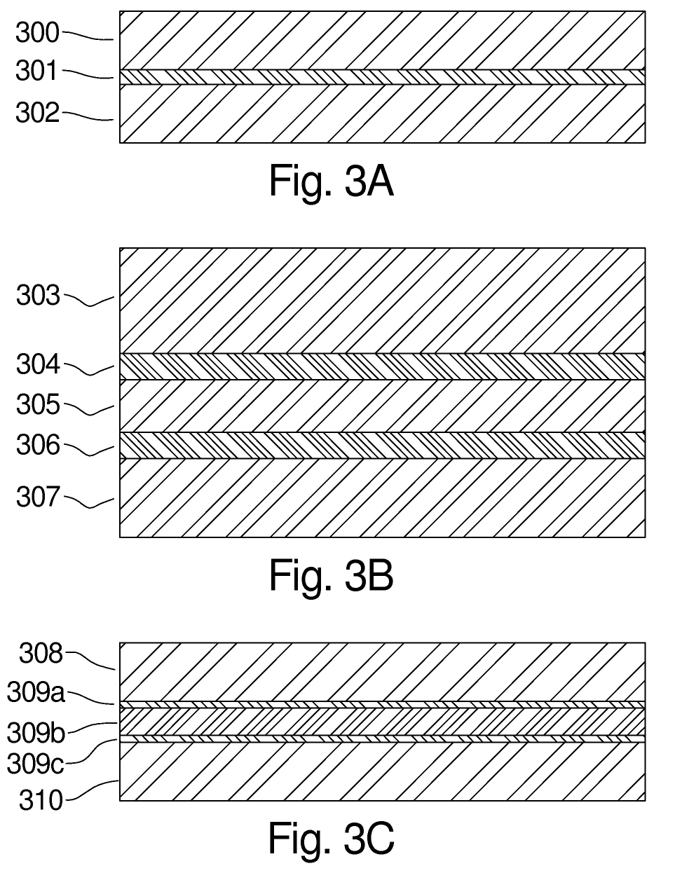

FIG. 3A shows a preferred cross section of the fused structure. An upper metal strip 300 is bonded to a filler polymer 301, which in turn, is bonded to a lower metal strip 302. The upper metal strip 300 and lower metal strip 302 may be the same or different thicknesses, and they may be different metals. In a preferred embodiment, either of the two metal strips are primarily iron or aluminum. Most preferably, either metal strip is primarily steel. Optionally, a decorative or corrosion preventing coating can be on the exterior of either the upper and lower metal strips.

FIG. 3B shows another preferred cross section of the fused structure. An upper metal strip 303 is bonded to a filler polymer 304, which is bonded to a middle metal strip 305, which is bonded to another filler polymer 306, which is bonded to a lower metal strip 307. Any of the three metal strips can be a different material. The two filler polymers may be a different material. Optionally, a decorative or corrosion preventing coating can be on the exterior of the upper and lower metal strips. The middle metal strip may be very thin, such as a foil.

Alternately, in FIG. 3B, the middle metal strip 305 may be a different material such as fiberglass, cardboard, paper, foam, vinyl, or rubber.

FIG. 3C illustrates an upper metal strip 308 that is bonded to a filler polymer which consists of three polymer layers 309a, 309b, 309c, which in turn, are bonded to a lower metal strip 310. Polymer layers 309a and 309c provide needed adhesion between the upper and lower metal strips 308, 310, and the middle portion of the filler polymer 309b. FIGS. 3A-3C are not to scale. In general, the width of a metal strip is much greater than the thickness.

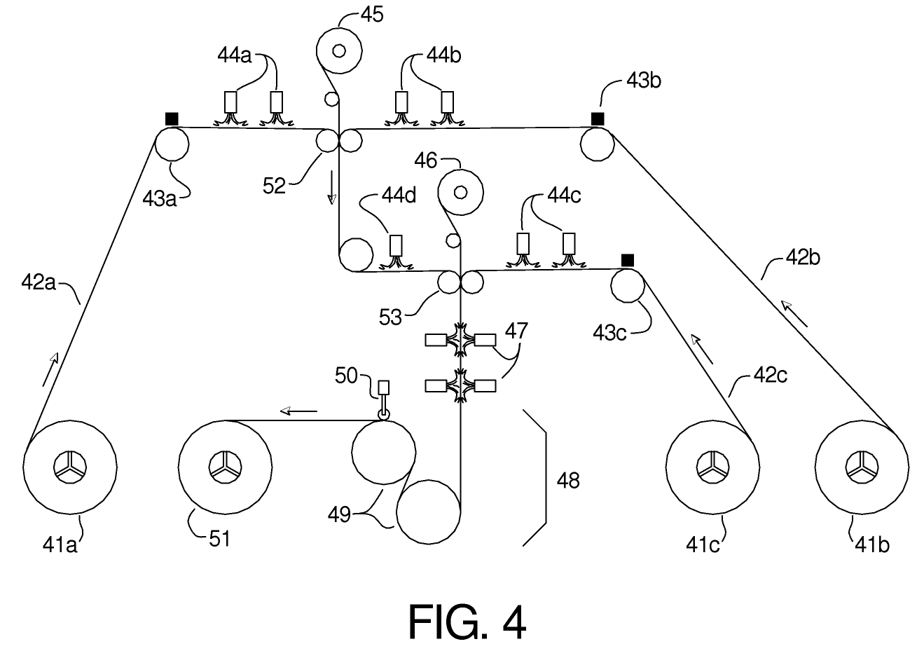

FIG. 4 shows a method where by a fused structure as shown in FIG. 3B may be efficiently created. Three similar unwind reels 41a, 41b, 41c continuously pay off metal strip 42a, 42b, 42c to a surface pretreatment section consisting of an optional corona treatment 43a, 43b, 43c and a controlled surface flame treatment 44a, 44b, 44c. The amount of energy used in the controlled surface flame pretreatment 44a, 44b, 44c is large enough to cause the temperature of the metal to rise significantly, to a temperature suitable for bonding to the solid filler polymer film. A roll of filler polymer film 45 pays into the nip between a pair of pressure rolls 52 which ensure that the film and metal strips 42a, 42b are in complete contact across their width. The partially fused structure is then optionally preheated by a controlled surface treatment 44d. A second filler polymer film 46 then bonds the third metal strip 42c to the partially fused structure where a second pair of nip rolls 53 ensures complete contact across the width. The five layer fused structure is then optionally reheated by optional flame reheating burners 47. This step provides a boost in metal temperature, if needed, to ensure that both films bond completely to the metal strips. An optional short delay section 48 may be employed if the chemical bond between the filler polymer film and the metal surfaces requires an activation time. Two temperature control rolls 49 cool the fused metal-polymer composite structure to a suitable temperature for winding on a winding reel 51. An optional side trimming operation 50 may be employed if any filler polymer significantly extends past the metal edges.

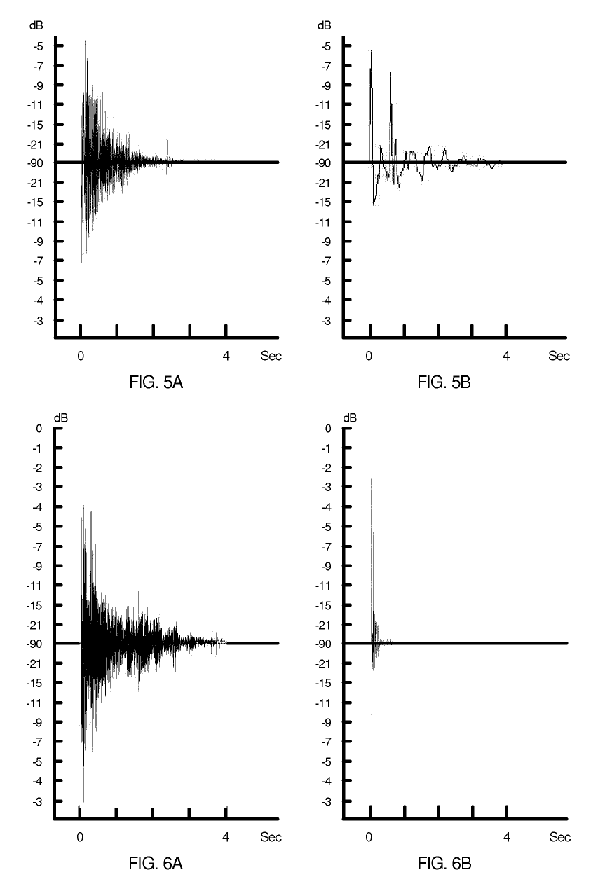

FIGS. 5A and 5B are two graphs demonstrating the sound deadening performance of a rectangular metal and polymer fused strip sample (example #1). The graph in FIG. 5A is a recording from a sound microphone held close to a galvanized steel sample 0.009″ thick, 6.4″ wide, and 12.4″ long. A small metal circular disk weighing 5.7 grams, 0.96″ diameter, and 1.75 mm thick was used to strike the sample. The sample rested on four rubber bumpers and was not clamped on any edge. The disk dropped from 18″ above the sample and struck the center of the sample on the edge of the disk without a significant bounce. As is seen in the graph, the sound recording showed a noise signature with very high frequencies, too high to be seen in the current graph. Data analysis of the sound signature revealed a significant resonant frequency in the 750-800 Hz range.

The graph in FIG. 5B is a similar sound recording from a sound deadening sample which is a fusion of two metal strips, of the same dimensions in FIG. 5A, with a 0.0004″ thick filler polymer from an anhydride modified polyethylene. The sample was prepared by bonding a sold film and the two metals together by pressing the structure together in a pair of nip rollers following the general teachings of FIG. 2. The fused structure was then post treated in an oven above the melting point of the filler polymer and air cooled. As is shown in the graph, the high frequency vibrations were practically eliminated, with only two significant sound spikes seen. After the initial sound spike and a second echo spike, the graph in FIG. 5B shows a residual low frequency sound of 1-2 Hz that is not audible to the human ear. The very thin filler polymer was surprisingly effective in sound dampening.

Similarly, FIGS. 6A and 6B show results from the same sound deadening sample with a higher activating force by dropping the disk 36″ above the sample. As shown, the results are the substantially the same as FIGS. 5A and 5B. In FIG. 5B the initial sound spike is higher and sound dampens quickly to a very low 20 Hz frequency, which is at the edge of human hearing.

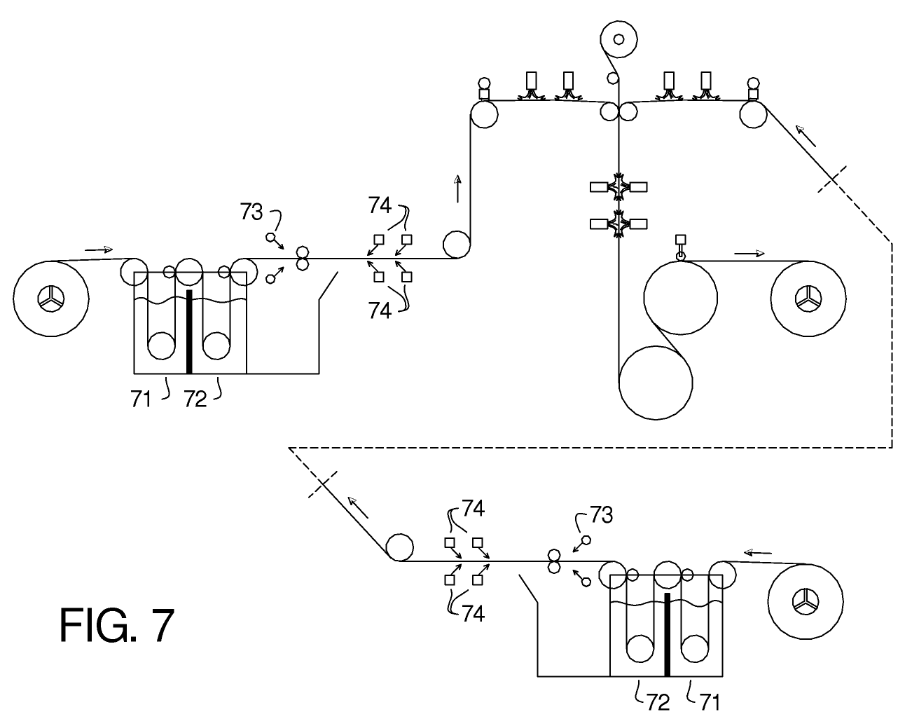

FIG. 7 is a modification of FIG. 2 where cleaning, rinsing, and the application of a corrosion inhibiting liquid organic coating are applied to the two metal strips. An alkaline cleaning tank 71 proceeds a rinse dipping tank 72 followed by a water based thin organic coating sprays 73 with a corrosion inhibitor, followed by hot air blow off headers 74. The corrosion inhibitor is preferably based on a chromium compound, but other corrosion inhibiting compounds may be used. Alternately, sprays may be used rather than dipping tanks for the cleaning and rinsing sections. Both metal strips may have the same cleaning, rinsing, and organic coating sections, or they may be different. Surface passivation or conversion coating may also be included.

Example #2: a test panel of metal and polymer fused strip was created. A thee layer filler polymer consisting primarily of polyester was inserted between two galvanized steel strips, each of which was 0.010″ thick. Both of the galvanized steel strips were pretreated by a controlled surface flame and preheated to 350° F. prior to contact with the filler polymer. In sequence, the fused metal and polymer strip composite structure was: galvanized steel strip 0.010″ thick, an anhydride modified ethylene acrylate polymer 0.2 mils thick, a polyester (PBT) 1.6 mils thick, an anhydride modified ethylene acrylate polymer 0.2 mils thick, and a galvanized steel strip 0.010″ thick. The metal, three layer filler polymer, and metal structure were pressed together. The resulting combined structure was then post treated above the melting point of the polyester and air cooled. The resulting flat panel was examined closely and tested. It contained very satisfactory adhesion and sound deadening qualities. The resonant frequency was significantly lowered, when struck firmly, and the sound amplitude was also significantly lowered when compared to flat steel panels of similar size 0.010″ thick.

Human hearing is limited to the range of about 20 Hz to 20 KHz depending upon the age of the individual. Frequencies in this range are the most important from a sound dampening standpoint.

As already mentioned, it has been discovered by the experimental results that the sound dampening material of the present invention primarily works to reduce the natural resonant frequency of a metal part. Based on samples that were measured, the dampening is capable of lowering the frequency as well as reducing the amplitude after the initial striking force. It was also readily observable for the experimenter to hear the change to a lower frequency when the samples were struck.

Metal square and rectangular samples have known resonant frequencies. The frequencies may be computed through methods such as finite element analysis. A square plate, also called a Chladni plate, has resonant frequencies approximated by:

$${f}_{m} = π t {( \frac{m}{a} )}^{2} \sqrt{\frac{{g}_{C} E}{12 ρ ( 1 - {υ}^{2} )}} \qquad eqn 1$$

where

m=1, 2, 3, . . .

t=thickness of metal square

a=side length of metal square

g_{C}=gravitational constant, i.e. 386 in-lbm/lbf-sec²

E=modulus of elasticity of metal

ρ=density of metal

ν=poisson's ratio of metal

Similarly, a rectangular plate has resonant frequencies approximated by:

$${f}_{mn} = \frac{π}{2} t ( \frac{{m}^{2}}{{a}^{2}} + \frac{{n}^{2}}{{b}^{2}} ) \sqrt{\frac{{g}_{C} E}{12 ρ ( 1 - {υ}^{2} )}} \qquad eqn 2$$

Additionally, where

n 1, 2, 3, . . .

b side length of rectangular square

These equations are based on membrane theory where the sides of the rectangle or square is large compared to the thickness. Generally, a ratio of more than 80 to 1 is needed for membrane theory to apply.

Based on the graphs in FIGS. 5A, 5B, 6A, and 6B, whereby the natural resonant frequency of the sample panels are examined, the sound deadening properties are applied to the natural resonant frequencies of the metal sample. For example, in FIGS. 5A and 5B, the natural frequency is measured around 750-800 Hz and the likely modal resonant frequencies are in the next table:

| Mode | Calculated |
|---|---|
| (m, n) | Frequency (Hz) |
| 2, 11 | 765 |
| 3, 10 | 752 |
| 4, 9 | 793 |
| 5, 7 | 803 |
| 6, 2 | 782 |

In another preferred embodiment, the two metal skins are a different metal thickness. This provides additional sound deadening properties by preventing the resonant frequencies of the two metal skins from coinciding. Resonance in the overall part is then harder to establish. Preferably, the thicker plate is at least 5% more than the thinner one to establish a significant frequency interference between the two metal plates.

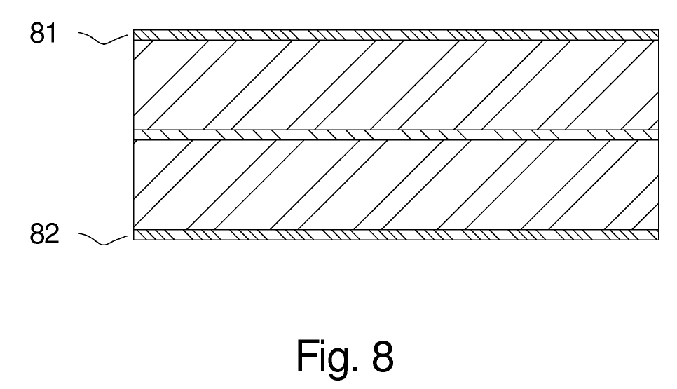

A preferred embodiment of the present invention is to additionally coat the exterior of the fused metal-polymer-metal structure as illustrated in FIG. 8 with an organic based coating, such as a paint, varnish, lacquer, laminate film, extruded coating, or an extrusion-laminated coating. The exterior can be coated in line with the present invention, for example, utilizing the methods as described in U.S. patent application Ser. No. 10/233,369 filed on Aug. 31, 2002 which is included herein by reference.

As shown in FIG. 8, the upper exterior decorative coating 81 and the lower exterior decorative coating 82 are placed by an extrusion coating as described in U.S. patent application Ser. No. 10/233,369. Commercial coil paint lines using the roll coating method are known in the art may also be used to apply an external organic coating.

Alternately, an external coating may be applied for the purpose of corrosion protection. Undercoating methods are used in the automotive field to protect metal parts from corrosion due to rain, road salt, moisture, and the general environment. These coatings and their application to a metal surface are known in the art.

In a preferred embodiment, an external sound dampening material may be applied to an external metal surface of the fused polymer metal composite to provide for additional sound deadening capability. The external sound dampening material may be tightly adhered to the exposed metal, such as by glue or tape. Such dampening may include rubber, foam, carpet, carpet padding, cloths, and known sound deadening materials.

The selection and application of commercial sound deadening materials, such as carpet, carpet padding, rubber, or foam, that is loosely applied to the outside of the fused metal and polymer composite structure is obvious to those skilled in the art and is not part of the present invention.

The surfaces of the metal and polymer fused strip may be decorated by embossing, stamping texturizing, printing, and coloring to provide suitable cosmetic appearance. Also, the surfaces may be adapted for additional sound dampening by the addition of foams and other materials that are known in the art to provide sound dampening.

While various embodiments of the present invention have been described, the invention may be modified and adapted to various similar arrangements to those skilled in the art. Therefore, this invention is not limited to the description and figures shown herein, and includes all such embodiments, changes, and modifications that are encompassed by the scope of the claims.

We claim:

1. A method to produce a continuous metal and polymer fused strip useful for sound deadening purposes comprising:
a. a first continuous metal strip moving at a predetermined speed,
b. a second continuous metal strip moving substantially at said predetermined speed,
c. pretreating a major side of said first continuous metal strip by at least one of the following two steps in any sequence:
i. increasing the surface energy, and
ii. heating,
d. pretreating a major side of said second continuous metal strip by at least one of the following two steps in any sequence:
i. increasing the surface energy, and
ii. heating,
e. selecting a first film of a first filler polymer wherein said first filler polymer has adhesive qualities to said first continuous metal strip and to said second continuous metal strip,
f. wherein said first film is either solid or molten,
g. passing said first continuous metal strip and said second continuous metal strip through a first pair of pressure rolls wherein a first opening between said first continuous metal strip and said second continuous metal strip exists just prior to said first pair of pressure rolls,
h. causing said first film to be placed into said first opening and to contact said major side of said first continuous metal strip and said major side of said second continuous metal strip thereby creating a first composite structure, and
i. cooling said first composite structure a first time,
whereby said continuous metal and polymer fused strip is created.

2. The method as set forth in claim 1 wherein said first composite structure is further processed by the following two additional steps:
j. heating said first composite structure, and
k. cooling said first composite structure a second time.

3. The method as set forth in claim 1 wherein said first filler polymer incorporates at least one of the following adhesive promoting compounds:
a. ethylene-vinyl acetate copolymers,
b. ethylene-methyl acrylate copolymers,
c. ethylene-butyl acrylate copolymers,
d. ethylene-acrylic ester-maleic anhydride terpolymers,
e. ethylene-acrylic ester-glycidyl methacrylate terpolymers,
f. ethylene-vinyl acetate-maleic anhydride terpolymers,
g. maleic anhydride grafted polyolefins,
h. ethylene acrylic acid,
i. epoxy,
j. glycol modified polyester, and
k. phenolic.

4. The method as set forth in claim 1 wherein a weight majority of said first filler polymer is polypropylene, polyethylene, polycarbonate, polyester, a copolymer of acrylonitrile-butadiene-styrene, polystyrene, polyvinylchloride, vinyl, acetal, nylon, polyurethane, polyamide, polyarylate, polyetherimide, polyetherketone, polyphenylene sulfide, rubber, or polysulfone.

5. The method as set forth in claim 1 wherein said first film of said first filler polymer is a co-extruded molten film or a solid film manufactured by a separate co-extrusion process.

6. The method as set forth in claim 1 wherein a weight majority of said first filler polymer is foam.

7. The method as set forth in claim 1 wherein any said continuous metal strip has at least one surface primed prior to any said pretreating.

8. The method as set forth in claim 1 wherein said continuous metal and polymer fused strip provides a sound dampening effect for any resonant frequency between 20 to 20,000 hertz in a finished part.

9. The method as set forth in claim 8 wherein said finished part is used in a transportation vehicle.

10. The method as set forth in claim 8 wherein said finished part is used on the exterior side of a building or on a roof of a building.

11. The method as set forth in claim 8 wherein said finished part is used in a heating and ventilating system.

12. The method as set forth in claim 8 wherein said finished part is used in a refrigerator, dishwasher, clothing washer, or a clothing dryer.

13. The method as set forth in claim 8 wherein said finished part is used in a fan or a fan support.

14. The method as set forth in claim 1 wherein a polymer side trimming operation removes any of said first filler polymer that extends beyond the edges of any said continuous metal strips.

15. The method as set forth in claim 14 wherein any portion of said first filler polymer that is trimmed is recycled.

16. The method as set forth in claim 1 wherein an organic coating is applied to any exterior major surface of said first composite structure.

17. The method as set forth in claim 16 wherein said organic coating is a paint, an extrusion coating, a laminate coating, a coating applied for corrosion protection, or an extrusion laminate coating.

18. The method as set forth in claim 1 wherein
a. said first composite structure moves at said predetermined speed,
b. a third continuous metal strip moving substantially at said predetermined speed,
c. preparing a major side of said first composite structure by at least one of the following two steps in any sequence:
i. increasing the surface energy, and
ii. heating,
d. pretreating a major side of said third continuous metal strip by at least one of the following two steps in any sequence:
i. increasing the surface energy, and
ii. heating,
e. selecting a second film of a second filler polymer wherein said second filler polymer has adhesive qualities to said first composite structure and to said third continuous metal strip,
f. wherein said second film is either solid or molten,
g. passing said first composite structure and said third continuous metal strip through a second pair of pressure rolls wherein a second opening between said first composite structure and said third continuous metal strip exists just prior to said second pair of pressure rolls,
h. causing said second film to be placed into said second opening and to contact said major side of said first composite structure and said major side of said third continuous metal strip thereby creating a second composite structure, and
i. cooling said second composite structure a first time,
whereby said second composite structure has useful sound deadening properties.

19. The method as set forth in claim 18 wherein said second composite structure is further processed by the following two additional steps:
j. heating said second composite structure, and
k. cooling said second composite structure a second time.

20. The method as set forth in claim 18 wherein any said filler polymer incorporates at least one of the following adhesive promoting compounds:
a. ethylene-vinyl acetate copolymers,
b. ethylene-methyl acrylate copolymers,
c. ethylene-butyl acrylate copolymers,
d. ethylene-acrylic ester-maleic anhydride terpolymers,
e. ethylene-acrylic ester-glycidyl methacrylate terpolymers,
f. ethylene-vinyl acetate-maleic anhydride terpolymers,
g. maleic anhydride grafted polyolefins,
h. ethylene acrylic acid,
i. epoxy,
j. glycol modified polyester, and
k. phenolic.

21. The method as set forth in claim 18 wherein a weight majority of any said filler polymer is polypropylene, polyethylene, polycarbonate, polyester, a copolymer of acrylonitrile-butadiene-styrene, polystyrene, polyvinylchloride, vinyl, acetal, nylon, polyurethane, polyamide, polyarylate, polyetherimide, polyetherketone, polyphenylene sulfide, rubber, or polysulfone.

22. The method as set forth in claim 1 wherein said first film incorporates holes.

23. The method as set forth in claim 18 wherein any said film incorporates holes.
